(19) United States
(12) Patent Application Publication
(10) Pub. No.: US 2010/0227119 A1
(43) Pub. Date: Sep. 9, 2010

(54) PROCESS FOR PLASMA COATING A POLYPROPYLENE OBJECT

(76) Inventors: Angela Taha, Monterey, CA (US); Christopher M. Weikart, Midland, MI (US); Hoang T. Pham, Lake Jackson, TX (US); Terry W. Glass, Lake Jackson, TX (US); Matthew Larive, Bay City, MI (US); Jason C. Brodil, Richardson, TX (US)

Correspondence Address: The Dow Chemical Company, P.O. BOX 1967, Midland, MI, 48641, US

(21) Appl. No.: 12/682,952

(22) PCT Filed: Oct. 8, 2008
(86) PCT No.: PCT/US2008/079137

§ 371 Date: Apr. 14, 2010

Related U.S. Application Data
(60) Provisional application No. 60/980,005, filed on Oct. 15, 2007.
(60) Provisional application No. 60/981,609, filed on Oct. 22, 2007.

(51) Int. Cl. B32B 3/00; C08J 7/00; B05D 7/24; B29C 59/00

(52) U.S. Cl. 428/141; 427/489; 264/129

(57) ABSTRACT

A process for improving the barrier performance of a plasma coated object comprising a polyolefin is disclosed. The process involves ensuring that the surface of the object to be coated is smooth as characterized by having a root-mean-square surface roughness that varies by less than the thickness of the coating to be applied, typically less than 100 nm. The invention also relates to a process for improving the stain resistance of polyolefin based articles comprising plasma polymerizing an organosilicon compound under conditions to deposit a polyorganosiloxane layer onto the article and/or (b) plasma polymerizing a organosilicon compound under conditions to deposit a silicon oxide layer directly on the article or onto a polyorganosiloxane layer prepared according to step (a).

### CROSS-REFERENCE TO RELATED APPLICATIONS

This application is a non-provisional application claiming priority from the U.S. Provisional Patent Application No. 60/980,005, filed on Oct. 15, 2007, entitled “PROCESS FOR PLASMA COATING A POLYPROPYLENE OBJECT,” the teachings of which are incorporated by reference herein, as if reproduced in full hereinbelow. This application also claims priority from the U.S. Provisional Patent Application No. 60/981,609, filed on Oct. 22, 2007, entitled “PROCESS FOR PLASMA COATING A POLYPROPYLENE OBJECT,” the teachings of which are incorporated by reference herein, as if reproduced in full hereinbelow.

### BACKGROUND AND SUMMARY OF THE INVENTION

The oxygen permeability of polypropylene bottles is typically inferior to similar bottles made with polyethylene terephthalate (PET). One way of improving the barrier resistance of polypropylene bottles is to provide a thin coating on the surface of the polypropylene. Such coatings are advantageously applied via plasma coating technology. Despite such technology, the plasma coated polypropylene bottles are still seen as inferior to PET bottles in terms of oxygen barrier performance. Accordingly improved barrier performance for polypropylene based bottles is still sought.

The instant invention is a solution, at least in part, to the above-stated problem. It has been discovered that the barrier performance of coated bottles is adversely affected by the inner wall surface topography. Substantially improved barrier properties have been observed when the inner wall topography varies by less than the thickness of the coating being applied. Typically, it is preferred that the surface topography be smooth as characterized by having a root mean-square surface roughness that varies by less than 100 nanometers, with a variance of less than 50 nanometers even more preferred.

Accordingly in one aspect of the invention, a polypropylene bottle is provided which can be characterized by having an inner surface topography such that the variance from the highest point to the lowest point is less than 100 nanometers.

Several techniques have been identified to achieve such smooth surface topography. Methods include adjusting the injection molding conditions during pre-form fabrication, using an optimized resin design, and the use of a highly polished pre-form mold core pin. Accordingly, another aspect of the present invention is therefore a method of producing a polypropylene bottle having a smooth inner surface topography comprising the step of using one or more of the above recited techniques.

Once the polypropylene bottles of the present invention have been prepared, barrier coatings can be applied using plasma coating technology known in the art. One particularly favored coating system is described in WO2006/12156, hereby incorporated by reference in its entirety. Such coated bottles can be characterized by their oxygen barrier performance. Thus, still another aspect of the present invention is plasma coated polypropylene bottles having certain oxygen barrier performance characteristics.

### DETAILED DESCRIPTION OF THE INVENTION

One aspect of the present invention is a method for improving the oxygen barrier performance of a plasma coated object comprising a polyolefin resin. The process includes the step of ensuring that the surface of the object to be coated has a root-mean-square surface roughness that varies by 100 nanometers or less, more preferably by 50 nanometers or less.

The root-mean-square surface roughness (“RMS”) is the geometric mean deviation of all the points on the surface from the mean value of the data, which can be represented according to the formula:

RMS=[Σ(Zᵢ−Z_{avg})²/N]^{1/2}

Where Zᵢ is the height image at data point i; Z_{avg} is the average of the height images across all data points and N is the total number of data points.

In order to obtain the roughness measurements, Atomic Force Microscopy (AFM) imaging can be used. One suitable AFM imaging instrument is a Digital Instruments Nano Scope IV, MultiMode J AFM in Tapping Mode with phase detection. Nano-sensor tips can be used. Suitable operating parameters include, for example, a tip having L of 235 microns, a tip ratio of 5-10 nm a spring constant of 37-55 N/m, F0 of 159-164 kHz, a tapping ratio of 0.83 and a tuning voltage set at 1.5v. Post processing of images can be conducted using software such as Adobe Photoshop v 7.0. The calculations can be done using Digitial Instruments/Veeco software for the Digital Instruments Nano Scope IV (software version 5.30r3sr3.

The object to be coated comprises a polyolefin material. Polyolefin objects are typically formed in a process that includes the step of introducing a polyolefin resin into a mold comprising a surface which corresponds to the surface of the object to be coated. In some cases the object may be formed in a two part process such as in the case of injection stretch blow molding (“ISBM”) where polyolefin resin is first injected around a core pin to form a pre-form mold and then in a second step, air or other inert gas is forced into the pre-form mold so that the pre-form mold expands to fill the object mold. In other cases such as injection molding, the finished part is formed by directly injecting the molten resin into the object mold.

One way of contributing to the smoothness of the surface of the object to be coated is to ensure that the surface of the pre-form mold or object mold which corresponds to the surface to be coated is smooth. This can be done for metal surfaces by polishing the surface. Preferably the surface of the pre-form or object mold corresponding to the surface to be coated is polished to a finish of A3, more preferably A2 or even smoother as set forth in the Mold Finish Guide available from the Society of the Plastics Industry (SPI), as published on Dec. 31, 1988. (All surface ratings mentioned in this patent application are in reference to that guide.) Thus for example, in the case of injection stretch blow molding the surface of the core pin is preferably polished to a finish of A2 or smoother. Another way of maximizing the smoothness of the surface to be coated is to control the extrusion rate such that the shear stress experienced by the flowing polymer is less than about 2×10⁵ Pa as determined according to ASTM D3835-02 where the shear stress at onset of melt instability is determined via observation of the extrudate surface. For polypropylene based resins, the shear stress may preferably be less than about 1.7×10⁵ Pa, more preferably less than about 1.5×10⁵ Pa still more preferably less than about 1.2×10⁵ Pa and most preferably less than about 1.1×10⁵ Pa.

The preferred material for use as the object to be coated in the present invention comprises a polypropylene component. The polypropylene component can be high crystalline polypropylene (such as those described in WO 2004/033509, which is hereby incorporated by reference in its entirety), homopolymer polypropylene, a random copolymer of propylene and an alpha olefin having 2 carbon atoms and/or from 4 to 12 carbon atoms, an impact copolymer polypropylene or a reactor grade propylene based elastomer or plastomer (such as those described in WO03/040201, which is hereby incorporated by reference in its entirety). These polypropylene materials are generally well-known in the art. It is also contemplated that the object to be coated may comprise two or more of these materials blended or otherwise combined together. Suitable polypropylene components include those polypropylene materials described in WO2006/12156, which is hereby incorporated by reference in its entirety.

When a reactor grade propylene based elastomer or plastomer is desired to be used, the reactor grade propylene based elastomer or plastomers which have an MWD (as determined by gel permeation chromatography) of 3.5 or less and having a heat of fusion (as determined by differential scanning calorimetry) less than about 100 or even 90 joules/gm may be particularly preferred.

The heat of fusion for these materials is measured by differential scanning calorimetry (DSC) using a Q1000 TA Instrument or similar instrument. In this measurement a ten milligram sample of the propylene polymer is sealed into an aluminum DSC pan. The sample is placed into a DSC cell with a 25 cubic centimeter per minute nitrogen purge and cooled to about minus 100 degrees Celsius. A standard thermal history is established for the sample by heating it at 10 degrees Celsius per minute to 225 degrees Celsius. The sample is kept at 225 degrees Celsius for 3 minutes to ensure complete melting. The sample then is cooled at 10 degrees Celsius per minute to about −100 degrees Celsius.

The sample is again kept isothermal at −100 degrees Celsius for 3 minutes to stabilize. It is then reheated at 10 degrees Celsius per minute to 225 degrees Celsius. The observed heat of fusion (ΔH observed) for the second scan over a range of 80-180 degrees Celsius is recorded.

Furthermore in some situations, for example when increased impact resistance, particularly in conditions of sub-ambient temperature, is desired, it may be beneficial to include an amount of an ethylene-alpha-olefin copolymer with the polypropylene material(s), where the alpha-olefin has from 3 to 12 carbon atoms and the ethylene-alpha olefin component and the polypropylene component are blended prior to extruding and injecting the molten polypropylene resin into the mold (either the pre-mold or the object mold). Preferred alpha olefins for use as the comonomer in such materials include 1-octene, 1-hexene and 1-butene. Preferably the ethylene-alpha-olefin is optimized for optics and rubber particle dispersion within the polypropylene matrix such as is taught in WO 2004/033509. If present, it is preferred that the ethylene-alpha-olefin copolymer be present in an amount of from five to thirty percent by weight of the total resin.

The process of coating the surfaces the present invention can be advantageously carried out using any of the microwave plasma coating apparatus described in WO03100121 and WO0066804 or RF plasma coating apparatus in WO9815669. The preferred material for coating the surfaces of the present invention include the polyorganosiloxane and/or SiOx layers described in WO2006/12156

Deposition of polyorganosiloxane and/or SiOx layers on the surface can be accomplished as follows as described in WO2006/12156. In general, the process involves flowing a mixture of gases including a balance gas and a working gas (together, the total gas mixture) through an injector at such a concentration and power density, and for such a time to create coatings with desired properties.

As used herein, the term “working gas” refers to a reactive substance, which may or may not be gaseous at standard temperature and pressure, that is capable of polymerizing to form a coating onto the substrate. Examples of suitable working gases include organosilicon compounds such as silanes, siloxanes, and silazanes. Examples of silanes include tetramethylsilane, trimethylsilane, dimethylsilane, methylsilane, dimethoxydimethylsilane, methyltrimethoxysilane, tetramethoxysilane, methyltriethoxysilane, diethoxydimethylsilane, methyltriethoxysilane, triethoxyvinylsilane, tetraethoxysilane (also known as tetraethylorthosilicate or TEOS), dimethoxymethylphenylsilane, phenyltrimethoxysilane, 3-glycidoxypropyltrimethoxysilane, glycidoxypropyltrimethoxysilane, 3-methacrylpropyltrimethoxysilane, diethoxymethylphenylsilane, tris(2-methoxyethoxy)vinylsilane, phenyltriethoxysilane, and dimethoxydiphenylsilane. Examples of siloxanes include tetramethyldisiloxane, hexamethyldisiloxane, and octamethyltrisiloxane. Examples of silazanes include hexamethylsilazanes and tetramethylsilazanes. Siloxanes are preferred working gases, with tetramethyldisiloxane (TMDSO) being especially preferred.

As used herein, the term “balance gas” is a reactive or non-reactive gas that carries the working gas through the electrode and ultimately to the substrate. Examples of suitable balance gases include air, O₂, CO₂, NO, N₂O as well as combinations thereof. Oxygen (O₂) is a preferred balance gas.

When a polyorganosiloxane layer is desired in the instant invention, a first organosilicon compound is plasma polymerized in an oxygen rich atmosphere on the inner surface of the container, which may or may not be previously subjected to surface modification, for example, by roughening, crosslinking, or surface oxidation. As used herein, the term “oxygen-rich atmosphere” means that the balance gas contains at least about 20 percent oxygen, more preferably at least about 50 percent oxygen. Thus, for the purposes of this invention, air is a suitable balance gas, but N₂ is not.

The quality of the polyorganosiloxane layer is virtually independent of the mole percent ratio of balance gas to the total gas mixture up to about 80 mole percent of the balance gas, at which point the quality of the layer degrades substantially. The power density of the plasma for the preparation of the polyorganosiloxane layer is preferably greater than 10 MJ/kg, more preferably greater than 20 MJ/kg, and most preferably greater than 30 MJ/kg; and preferably less than 1000 MJ/kg, more preferably less than 500 MJ/kg, and most preferably less than 300 MJ/kg.

In this step, the plasma is sustained for preferably less than 14 seconds, more preferably less than 7 seconds, and most preferably less than 5 seconds; and preferably greater than 0.1 second, and more preferably greater than 0.5 second to form a polyorganosiloxane coating having a thickness of preferably less than 50 nanometer, more preferably less than 20 nanometer, and most preferably less than 10 nanometer; and preferably greater than 2.5 nanometer, more preferably greater than 5 nanometer (nm).

Preferably the polyorganosiloxane coating step is carried out at a deposition rate of less than about 50 nanometer/sec, more preferably less than 20 nanometer/sec, and preferably greater than 5 nanometer/sec, and more preferably greater than 10 nanometer/sec.

The preferred chemical composition of the polyorganosiloxane layer is SiOxCyHz, where x is in the range of 1.0 to 2.4, y is in the range of 0.2 to 2.4, and z is greater than or equal to 0, more preferably not more than 4.

When a silicon oxide layer is desired in the instant invention, an organosilicon compound (which may be the same as or different from the organosilicon compound discussed above) is plasma polymerized to form a silicon oxide layer on the polyorganosiloxane layer described above, or a different polyorganosiloxane layer, or directly on the object. In other words, it is possible, and sometimes advantageous, to have more than one polyorganosiloxane layer of different chemical compositions (or no polyorganosiloxane layer). Preferably, the silicon oxide layer is an SiOx layer, where x is in the range of 1.5 to 2.0.

For the silicon oxide coating step, the mole ratio of balance gas to the total gas mixture is preferably about stoichiometric with respect to the balance gas and the working gas. For example, where the balance gas is oxygen and the working gas is TMDSO, the preferred mole ratio of balance gas to total gas is 85 percent to 95 percent. The power density of the plasma for the preparation of the silicon oxide layer is preferably greater than 10 MJ/kg, more preferably greater than 20 MJ/kg, and most preferably greater than 30 MJ/kg; and preferably less than 500 MJ/kg, and more preferably less than 300 MJ/kg.

It has been observed that when TDMSO is used as the working gas, the resulting coating appears to be particularly well suited for use in containers used to package materials of neutral to high pH. High pH solutions are known to etch glass-like coatings, particularly at higher temperatures such as experienced in hot-fill applications, and it is believed that they can affect the adherence of the coating on the substrate, thus causing a deterioration in the barrier performance. When TDMSO was used as the precursor, however the coatings appear to have unique properties that enable it to survive hot-fill applications at neutral to high ph and temperatures up to 100° C.

It has been observed that when radio-frequency plasma enhanced chemical vapor deposition is used (as opposed to the higher energy microwave plasma enhanced chemical vapor deposition), unwanted water byproducts from the working gas are more likely to be incorporated into the coatings as Si—OH. Some precursors such as hexamthlydisiloxane mixed with oxygen have been observed to produce relative low amounts of Si—OH in the resulting SiOx coating, and so may be preferred. Lower amounts of Si—OH enables the use of thinner SiOx coatings due to the inherently higher density compared to coatings containing higher amounts of the Si—OH.

In the silicon oxide coating step, the plasma is sustained for preferably less than 10 seconds, and more preferably less than 5 seconds, and preferably greater than 1 second to form a silicon oxide coating having a thickness of less than 50 nm, more preferably less than 30 nm, and most preferably less than 20 nm, and preferably greater than 5 nm, more preferably greater than 10 nm.

Preferably, the silicon oxide coating step is carried out at a deposition rate of less than about 50 nm/sec, more preferably less than 20 nm/sec, and preferably greater than 5.0 nm/sec, and more preferably greater than 10 nm/sec.

The thickness of the polyorganosiloxane layer, when used, is preferably less than 1000 nm, more preferably less than 100 nm, more preferably less than 40 nm, and most preferably less than 30 nm, and preferably greater than 10 nm. The thickness of the silicon oxide layer, when used, is preferably less than 100 nm, and preferably greater than 10 nm. The total plasma polymerizing deposition time is preferably less than 20 seconds, more preferably less than 10 seconds, and most preferably less than 5 seconds.

Coating adhesion is indicated according to the ASTM D-3359 tape test. The adhesion of a coating on an object is poor when greater than 65 percent of the coating delaminates, which corresponds to a “0” according to such test. The adhesion of a coating on an object is excellent when essentially none of the coating delaminates, which corresponds to a “5” according to such test.

The process of the present invention when used to coat a panel or sheet shaped object is advantageously, though not uniquely, carried out using the electrode discharge plasma coating apparatus and procedure described in U.S. Pat. Nos. 5,494,712 and 5,433,786 (both of which are fully incorporated herein by reference). When using such a system, the plasma polymerizing step(s) are preferably carried out at a power level of from 100 to 1000 KJ/kg and for a time of less than 1 minute (and more preferably for a time less than 30 second, and yet more preferably less than 5 seconds).

It should be understood that although the above discussion relates to microwave and electrode discharge plasma coating systems, the instant invention is not limited to any specific plasma coating system. Thus, any desired plasma coating system can be used in the instant invention.

The term “molded” used herein includes, without limitation thereto, blow molding (including injection stretched blow molding), roto-molding, thermoforming as well as injection molding.

It is preferred that the resulting coated object have an oxygen transmission rate (“OTR”) similar to PET, such as for a 500 ml isotonic beverage container, an OTR of 0.05 cc/package/day or less at 1 bar, as determined according to ASTM D3985, preferably even lower such as 0.025 or less, or even 0.01 cc/package/day or less.

Another way of characterizing the resulting coated object is the reduction of the oxygen transmission rate as compared to a similar object without any coating. It is preferred that the coated objects of the present invention exhibit at least a 20× reduction in the oxygen transmission rate over a similar uncoated object, more preferably at least a 40× reduction.

In addition to improving barrier properties of the coated object, it has been observed that the dimensional stability of beverage containers filled with hot fluids is improved as a result of the coatings deposited on the internal surface according to the teachings of the present invention. Thus coating containers according to the present invention may enable the use of lower modulus resins, reduce the overall container weight and allow less complicated bottle designs for hot-fill beverages.

It has also been discovered that containers with coatings of organosiloxane layers as described above can protect the container from staining. Household containers composed of commodity plastics such as polyethylene, polystyrene or polypropylene are known to exhibit various types of damage in use. One of the most common deficiencies is stain resistance to food products when used as a storage container or after reheating food in a microwave oven. The most common type of staining is caused by tomato based food products. Oils and sugars are also responsible for surface damage on the container, particularly during microwave heating. However, it has been observed that coated articles of the present invention exhibit improved resistance to such staining and deterioration. This is particularly true when the coated article comprises a polypropylene formulation containing an impact modifier that provides enhanced thermal stability. One preferred impact modifier is an ethylene-1-octene copolymer such as those sold by The Dow Chemical Company under the trade name AFFINITY™.

The present invention can be further understood by considering the following examples, which serve to illustrate the invention, without limiting the scope of the invention as claimed.

### Examples 1-6

A series of bottles were made using a blend comprising 81.2 percent by weight high crystalline PP homopolymer having a melt flow rate (230° C./2.16 kg) of 12 g/10 min and 18 percent ethylene 1-octene copolymer having a density of 0.902 g/cc and a melt index (190° C./2.16 kg) of 1 g/10 min with the balance being additives. Pre-forms of approximately 31 grams were fabricated from the blended resins using different injection speeds as reported in Table 1 and a core pin having a standard (that is, unpolished) finish.

The shear stress reported in Table 1 is determined as follows: For a given preform design, one can estimate the shear rate at which the polymer melt is filling into the preform as:

$${γ}_{w} = \frac{6 Q}{π ( {R}_{a} + {R}_{i} ) {( {R}_{a} - {R}_{i} )}^{2}} ;$$

where Q is volumetric flow rate of the polymer melt in the preform and Ra and Ri are the external and internal radii of the preform, respectively. Thus, the shear rate can be estimated once the injection speed and preform dimensions are specified. The shear stress can then be estimated as: τ_{w}=ηγ_{w}; where η is the shear viscosity of the polymer melt.

The resulting pre-forms were then stretch blow molded into beverage containers having an average surface area of 406.5 cm², with an average wall thickness of 30.5 mils. The average root-mean-square surface roughness for each resulting container was then measured as described in the detailed description of the invention, and these measurements are reported in Table 1. The bottles were then coated (except for Example 1, which was left uncoated as a comparative) internally by plasma enhanced chemical vapor deposition (PECVD) on a lab scale coater. Plasma is initiated by applying radio-frequency (that is, 13.56 MHz) energy to a gas mixture at low pressure (that is, <100 mTorr). The gas mixture is composed of an organosiloxane precursor and oxygen, which react in the plasma state to form polymerizing radical intermediates that deposit on the bottle wall. A mixture of tetramethyldisiloxane and oxygen were used to deposit the organosiloxane (SiOₓC_{y}H_{z}) layer followed by a layer of silicon oxide (SiOₓ) derived from a mixture of hexamethyldisilazane and oxygen. The coating process resulted in a layer of from 10-24 nm of a (SiOₓC_{y}H_{z}) material and a silicon oxide layer of 12-30 nm. The oxygen transmission rates (OTR) for each bottle was then determined according to ASTM D-3985. These results are also presented in Table 1. The OTR results demonstrate that average RMS roughness affects OTR and also demonstrates that the average surface roughness can be affected by the injection speed (or resulting shear rate).

TABLE 1

| | | | | | OTR | |
|---|---|---|---|---|---|---|
| | Injection | Shear | Shear | Avg. | (cc/ | Shear |
| | Speed | Rate | Viscosity | RMS | container/ | Stress |
| Example # | (cc/sec) | (sec⁻¹) | (Pa-sec) | Roughness (nm) | day) | (Pa) |
| 1 | 12 | 100 | 502 | 35 | 0.68 | 0.5 × 10⁵ |
| (uncoated) | | | | | | |
| 2 | 50 | 480 | 234 | 647 | 0.5 | 1.12 × 10⁵ |
| 3 | 6 | 50 | 703 | 19 | 0.11 | 0.35 × 10⁵ |
| 4 | 6 | 50 | 703 | 37 | 0.18 | 0.35 × 10⁵ |
| 5 | 6 | 50 | 703 | 29 | 0.16 | 0.35 × 10⁵ |
| 6 | 50 | 480 | 234 | 224 | 0.46 | 1.12 × 10⁵ |

### Examples 7-9

Another series of bottles were made using different materials as reported in Table 2. Resin A is 99.3 percent by weight of a high crystalline polypropylene homopolymer having a melt flow rate (230° C./2.16 kg) of 8 g/10 min, with the balance being additives. Resin B is a blend comprising 81.2 percent by weight high crystalline PP homopolymer having a melt flow rate (230° C./2.16 kg) of 12 g/10 min. and 18 percent ethylene 1-octene copolymer having a density of 0.902 g/cc and a melt index (190° C./2.16 kg) of 1 g/10 min., with the balance being additives. Resin C is 100 percent of a propylene-ethylene random copolymer with an ethylene content of 3.7 percent and a melt flow rate (230° C./2.16 kg) of 12 g/10 min. Pre-forms for each resin were fabricated using a standard (unpolished) core pin while attempting to keep the processing conditions constant with an injection speed of 6 cc/sec. The resulting pre-forms were then stretch blow molded into beverage containers. The average root-mean-square surface roughness for each resulting container was then measured as described in the detailed description of the invention, and these measurements are reported in Table 2.

The bottles were then coated using the same procedure described for Examples 1-6, such that the beverage containers were coated with a (SiOₓC_{y}H_{z}) layer of from 10-24 nm and a silicon oxide layer of 12-30 nm. The oxygen transmission rates (OTR) for each bottle was then determined according to ASTM D-3985. These results are also presented in Table 2. The results in Table 2 demonstrate that the choice of materials affects both the average RMS surface roughness and the OTR, but also demonstrates that the contribution of the coating to reduced OTR is improved by lower surface roughness no matter what the substrate is.

TABLE 2

| | | Avg. RMS | | OTR Coated |
|---|---|---|---|---|
| | | Roughness | OTR Uncoated | (cc/bottle |
| Example # | resin | (nm | (cc/bottle/day) | day) |
| 7 | A | 300 | 0.51 | 0.34 |
| 8 | B | 50 | 0.68 | 0.05 |
| 9 | C | 10 | 1.23 | 0.44 |

### Examples 10-11

A series of bottles were made using identical resin (resin C as described above) and identical processing conditions except that the core pin used to make the pre-form was either a standard finish (A3-B1) or a polished finish (A2-A3). The average root-mean-square surface roughness for each resulting container was then measured as described in the detailed description of the invention, and these measurements are reported in Table 2. These results are also presented in Table 3.

TABLE 3

| | Core Pin | Avg. RMS |
|---|---|---|
| Example # | Finish | roughness (nm) |
| 10 | Polished (A2) | 10.5 |
| 11 | Standard (less | 52.5 |
| | smooth than | |
| | A2) | |

### Examples 12-17

The resin blends as indicated in Table 4 are injected molded to make 1 liter capacity bowls having a weight of 71 grams. These bowls, with no pretreatment or cleaning, are then coated with organosiloxane (that is, SiOxCyHz) thin films by PECVD as described above. Coatings consisted of either a single layer or a multi layer and were as set forth in Tables 5 and Table 6. In the case of the multilayer structure, the first “adhesion” layer was composed of high carbon and low oxygen content, the second “transition” layer was composed of a gradient of decreasing carbon and increasing oxygen content, and a third “protective” layer was composed within the range SiO_{1.8-2.4}C_{0.3-1.0}H_{0.7-4.0}.

Stain testing is carried out by filling the bowls approximately ¾ full of spaghetti sauce and heating in a microwave oven on high for 4 minutes. The sauce was discarded and the bowls rinsed with DI water. Results of the stain testing are shown in Table 4. The extent of stain resistance and pitting resistance was ranked as “poor”, “moderate”, “good” or “excellent”. Both of the uncoated bowls made with either Resin A or Resin B exhibited poor stain resistance; however the bowls made with Resin B exhibited significantly better pitting resistance at the sauce fill-line. The coated bowls with either resin exhibit excellent stain resistance, but the bowls made with the impact modifier (Resin B) show significantly better pitting resistance at the sauce fill-line. It is also worth noting that the multilayer coatings having a much thicker protective layer show no substantial improvement over the single-layer coatings.

TABLE 4

| | | | Stain | Pitting |
|---|---|---|---|---|
| Example # | Resin | Coating | Resistance | Resistance |
| 12 | A | no | poor | poor |
| 13 | A | multi | Excellent | Moderate |
| 14 | A | single | Excellent | Moderate |
| 15 | B | no | Poor | moderate |
| 16 | B | multi | Excellent | Excellent |
| 17 | B | single | Excellent | Excellent |

TABLE 5

| | Process Parameters for multilayer coating | | | | | | |
|---|---|---|---|---|---|---|---|
| | | | | Power | | | |
| | | Flowrate | | Density | | | Coating |
| | Power | TMDSO | O₂ | W/FM | Time | Pressure | Thickness |
| Layers | (W) | (sccm) | | (KJ/kg) | (min) | (mTorr) | (micron) |
| Adhe- | 800 | 20 | 0 | 400 | 1 | 4 | <0.01 |
| sion | | | | | | | |
| Transi- | 800 | 20-50 | 40 | 400-134 | 1 | 4-10 | <0.01 |
| tion | | | | | | | |
| Protec- | 800 | 50 | 40 | 134 | 30 | 10 | 1 |
| tive | | | | | | | |

TABLE 6

| | Process Parameters for single layer coating | | | | | | |
|---|---|---|---|---|---|---|---|
| | | | | Power | | | |
| | | Flowrate | | Density | | | Coating |
| | Power | TMDSO | O₂ | W/FM | Time | Pressure | Thickness |
| Layer | (W) | (sccm) | | (KJ/kg) | (min) | (mTorr) | (nm) |
| Protec- | 800 | 50 | 40 | 134 | 1 | 10 | 60-70 |
| tive | | | | | | | |

What is claimed is:

1. A process for improving the barrier performance of a plasma coated object comprising a polyolefin, the process comprising a step of ensuring that the surface of the object to be coated is smooth as characterized by having a root-mean-square surface roughness that varies by less than 100 nm.

2. The process of claim 1 wherein the surface is characterized by having a root-mean-square surface roughness that varies by less than 50 nm.

3. The process of claim 1 wherein the object is a polypropylene object formed by a process which includes the step of introducing molten resin comprising a polyolefin into a mold comprising a surface which will correspond to the surface of the object to be coated.

4. The process of claim 3 wherein the step of introducing the molten resin comprising a polyolefin into a mold includes the steps of first injecting the resin around a core pin to form a preform and then forcing air or other inert gas into the preform so that the preform expands to fill the object mold, and wherein the surface of the core pin corresponds to the surface of the object to be coated.

5. The process of claim 4 wherein the preform is cooled after forming and the step of forming the object mold is not performed contemporaneously with the step of forming the preform.

6. The process of claim 4 wherein the smooth surface is obtained at least in part by ensuring that the core pin has a smooth surface.

7. The process of claim 6 wherein the surface of the core pin has been polished to a finish of A2 or smoother prior to use.

8. The process of claim 3 wherein the mold corresponds substantially to the desired shape of the final object and the mold comprises at least a first surface and a second surface, with the first surface corresponding to the surface of the object to be coated.

9. The process of claim 4 wherein the smooth surface is obtained at least in part by ensuring that the first surface of the mold is smooth.

10. The process of claim 9 wherein the first surface has been polished to a finish of A2 or less prior to use.

11. The process of claim 3 wherein the step of introducing molten resin comprising a polyolefin into a mold is controlled such that the shear stress is less than about 2×10⁵ Pa.

12. The process of claim 11 wherein the step of introducing molten resin comprising a polyolefin into a mold is controlled such that the shear stress is less than about 1.7×10⁵ Pa.

13. The process of claim 1 where the object is coated by a process comprising the steps of: (a) plasma polymerizing an organosilicon compound under conditions to deposit a polyorganosiloxane layer onto the object, the polyorganosiloxane layer being thicker than 5 nm; and/or (b) plasma polymerizing a organosilicon compound under conditions to deposit a silicon oxide layer directly on the object or onto a polyorganosiloxane layer prepared according to step (a), the silicon oxide layer being thicker than 5 nm.

14. The process of claim 13, wherein the polyorganosiloxane layer is present and comprises SiOxCyHz, where x is in the range of 1.0 to 2.4, y is in the range of 0.2 to 2.4, and z is in the range of 0 to 4.

15. The process of claim 13, wherein the silicon oxide layer is present and comprises SiOx, where x is in the range of 1.5 to 2.4.

16. The process of claim 3 wherein the resin comprises a polypropylene component that is selected from the group consisting of a) high crystalline polypropylene b) homopolymer polypropylene c) a random copolymer of propylene and an alpha olefin having 2 carbons and/or from 3 to 12 carbon atoms d) an impact copolymer polypropylene e) a reactor grade propylene based resin having MWD<3.5, and having heat of fusion less than about 100 joules/gm and f) blends of two or more of the foregoing.

17. The process of claim 16 wherein the polypropylene resin further comprises an ethylene-alpha-olefin polymer component wherein the alpha olefin has from 3 to 12 carbon atoms and the polypropylene component and the ethylene-alpha-olefin polymer component are combined prior to introducing the resin into the mold.

18. The process of claim 17 wherein the ethylene-alpha-olefin comprises from 0.1 percent by weight to 30 percent by weight of the resin composition.

19. The process of claim 17 where the alpha olefin is selected from the group consisting of 1-octene, 1-hexene, 1-butene.

20. The process of claim 1 where the resulting coated object is characterized by having an oxygen transmission rate of less than 500 cc/m2/day at 1 mil and 1 bar, as determined according to ASTM D3985.

21. The process of claim 2 wherein the resulting coated object is characterized as having at least a 30 percent reduction in the oxygen transmission rate of a similar object which has not been coated.

22. A process for improving the barrier performance of a plasma coated object comprising a polyolefin resin, the process comprising the step of ensuring that the surface of the object to be coated is smooth as characterized by having a root-mean-square surface roughness that varies by less than the thickness of the coating to be applied.

23. An article of manufacture, comprising: a) a body comprising a polyolefin composition and b) a coating comprising i) a polyorganosiloxane layer being thicker than 5 nm; and/or (ii) a silicon oxide layer being thicker than 5 nm; where the body has a surface that is characterized by having a root-mean-square surface roughness prior to coating that varies by less than 100 nm; wherein the article has a cross-hatch adhesion ranking according to the ASTM D-3359 test of the polyorganosiloxane layer, the silicon oxide layer or both on the body of greater than 3, and where the article has oxygen transmission rate of less than 500 cc/m2/day at 1 mil and 1 bar, as determined according to ASTM D3985.

24. A method to improve the stain resistance of an object comprising a polyolefin resin, the method comprising the steps of: (a) plasma polymerizing an organosilicon compound under conditions to deposit a polyorganosiloxane layer onto the object, the polyorganosiloxane layer being thicker than 5 nm; and/or (b) plasma polymerizing a organosilicon compound under conditions to deposit a silicon oxide layer directly on the object or onto a polyorganosiloxane layer prepared according to step (a), the silicon oxide layer being thicker than 5 nm.

25. The method of claim 24, wherein the polyorganosiloxane layer is present and comprises SiOxCyHz, where x is in the range of 1.0 to 2.4, y is in the range of 0.2 to 2.4, and z is in the range of 0 to 4.

26. The method of claim 24, wherein the silicon oxide layer is present and comprises SiOx, where x is in the range of 1.5 to 2.4.

27. The method of claim 24 wherein the polyolefin resin comprises a polypropylene component that is selected from the group consisting of a) high crystalline polypropylene b) homopolymer polypropylene c) a random copolymer of propylene and an alpha olefin having 2 carbons and/or from 3 to 12 carbon atoms d) an impact copolymer polypropylene e) a reactor grade propylene based resin having MWD<3.5, and having heat of fusion less than about 100 joules/gm and f) blends of two or more of the foregoing.
